(19) United States
(12) Patent Application Publication
(10) Pub. No.: US 2016/0343022 A1
(43) Pub. Date: Nov. 24, 2016

(54) System for Accessing Consumer Data Using a Universal Card

(71) Applicant: Laura Mora Sahagun, Los Angeles, CA (US)

(72) Inventor: Laura Mora Sahagun, Los Angeles, CA (US)

(21) Appl. No.: 15/158,846

(22) Filed: May 19, 2016

Related U.S. Application Data
(60) Provisional application No. 62/163,610, filed on May 19, 2015.

(51) Int. Cl. G06Q 30/02

(52) U.S. Cl. CPC G06Q 30/0227

(57) ABSTRACT

A system for storing consumer identifiers associated with businesses and retrieving the consumer identifiers utilizing a universal card. The system includes a card having a unique identifier assigned to the user stored thereon and a terminal having a unique identifier associated with the business stored thereon. The terminal is connected to a server architecture via a network. When the card is scanned at the terminal, the terminal queries the server with the unique identifier from the card and the unique identifier from the terminal. The server then returns a transaction identifier stored on a database in connection with the server to the terminal for application by the terminal. The transaction identifier can include a loyalty rewards program identifier, a ticker number, or any other such identifier associated with an economic transaction.

### CROSS REFERENCE TO RELATED APPLICATIONS

This application claims the benefit of U.S. Provisional Application No. 62/163,610 filed on May 19, 2015. The above identified patent application is herein incorporated by reference in its entirety to provide continuity of disclosure.

### BACKGROUND OF THE INVENTION

The present invention relates to systems and methods of storing and retrieving consumer data, such as loyalty rewards accounts and redeemable purchases. More specifically, the present invention relates to systems and methods of streamlining access to redeemable consumer information, such as redeemable purchases and loyalty account information, into a single, universal point of access in order to decrease the number of cards, tickets, and other articles that users need to carry on their person and/or have ready access to.

Many stores and online services provide consumers with membership or loyalty programs in order to incentivize future purchases. Membership often requires personal information from each consumer that allows the merchant to identify the individual during a transaction. In exchange for personal information, many merchants will provide a scanable card or a member number associated with the consumer's personal information. When the member number or card is used during a purchase, specific benefits can be applied to that purchase, such as discounts and rewards.

People that sign up for the membership benefits have to carry multiple types of loyalty cards or remember various membership numbers. However, carrying multiple cards is inconvenient due to the limited space provided in an individual's wallet or purse. Further, having to recall a membership number or find the location in which it was transcribed is cumbersome and not always possible when making an immediate purchase. Thus, when a membership card is misplaced or a membership number cannot be recalled for a particular store, it causes the user to miss out on potential benefits.

Additionally, online pre-paid purchases for such items as airline and concert tickets can be made prior to the date of use. As a result, the user often receives an email that enables the tickets to be printed, scanned, or otherwise used. Some individuals choose to immediately print their ticket, requiring them to keep track of the paper document until the date of use. Other individuals choose to search for the email after the date of purchase, which requires the individual to search through an abundance of email in order to find the desired purchase.

There are existing universal transaction cards that are capable of storing, receiving, and transmitting information for a plurality of service institutions. However, such devices do not incorporate a database that enables a user to create a profile and store various benefit and purchase information thereon for future use. Thus, a system and method for inputting and retrieving information on a database using a unique identifier associated with a universal card that can be used at any of various stores and online services is desired.

### SUMMARY OF THE INVENTION

An illustrative embodiment of the present computer includes a card storing a card user ID; a server in connection with a database; the database storing a user ID, a business ID associated with the user ID, and a transaction ID associated with the business ID of the used ID; a terminal storing a terminal business ID; and wherein scanning the card at the terminal causes the terminal to query the server with the card user ID and the terminal business ID via a network, whereupon the server returns to the terminal the transaction ID corresponding to the user ID matching the card user ID and the business ID matching the terminal business ID. In one embodiment of the present system, the transaction ID includes a loyalty program ID and a redeemable purchase ID. In embodiments of the present system wherein the transaction ID is the loyalty program ID, the terminal applies the loyalty program ID to discount a purchase upon receipt of the loyalty program ID. In embodiments of the present system wherein the transaction ID is the redeemable purchase ID, the terminal applies the redeemable purchase ID to acknowledge payment of a purchase.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of an illustrative embodiment of the present system.

FIG. 2 shows a flowchart of the method of use of an illustrative embodiment of the present system.

FIG. 3 shows a diagram of a data structure of an illustrative embodiment of the present system.

### DETAILED DESCRIPTION OF THE INVENTION

Reference is made herein to the attached drawings. Like reference numerals are used throughout the drawings to depict like or similar elements of the system for accessing consumer data using a universal card. The figures are intended for representative purposes only and should not be considered to be limiting in any respect.

As used herein, “ID” refers to an identifier consisting of one or more alphanumeric characters, one or more symbols, or any combination thereof. As used herein, “logic” refers to (i) logic implemented as computer instructions and/or data within one or more computer processes and/or (ii) logic implemented in electronic circuitry. As used herein, “computer-readable medium” excludes any transitory signals, but includes any non-transitory data storage circuitry, e.g., buffers, cache, and queues, within transceivers of transitory signals. In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

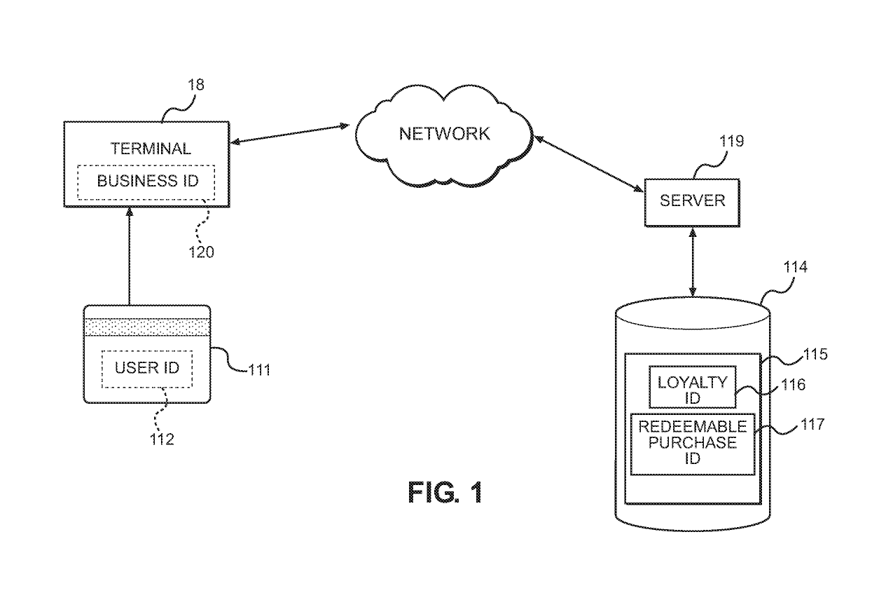

Referring now to FIG. 1, there is shown a diagram of an illustrative embodiment of the present system. The present system is intended to provide consumers and businesses with the ability to conveniently access consumer information related to transactions that the consumer has conducted with the businesses, including loyalty program membership and redeemable purchases, via a single universal card. The present system includes a card 111 having a user ID 112 stored thereon. The user ID 112 is a unique identifier, such as a string of alphanumeric characters, associated with a single account within the present system. In some embodiments of the present system, the user ID 112 is chosen by the user at the time that the user's account is created. In other embodiments of the present system, the user ID 112 is randomly assigned to the user upon account creation. In various embodiments of the present system, the card 111 includes a magnetic stripe, an RFID tag, a transponder, a microchip, or any other storage medium for storing the user ID 112 thereon.

The present system further includes a terminal 118 that is configured to read or otherwise receive the user ID 112 from the card 111 when the card is scanned at the terminal 118. The terminal 118 includes a point-of-sale (POS) terminal or any other such apparatus for receiving electronic information from the card 111. For example, in an embodiment of the present system wherein the card 111 has a magnetic stripe, the terminal 118 includes a magnetic stripe reader.

Each business or other entity participating in the present system is assigned a business ID 120 that is unique to that particular business. The business ID 120 can be a string of alphanumeric characters or any other desired identifier. The business ID 120 is stored in the non-transitory computer readable medium of the terminal 118 for later retrieval. The business ID 118 is used in conjunction with the user ID 112 to retrieve the consumer information from the server 119 that is relevant to the business. In an illustrative embodiment of the present system, the business ID 120 is associated with the business as a whole, rather to an individual terminal 118. In other words, each location of a business may share a business ID 120 associated with the business as a whole so that the relevant consumer information can be retrieved regardless of the location at which the user is located. In one embodiment of the present system, each business has a terminal 118 (with associated business ID 120 stored thereon) that is unique to that particular business. In another embodiment of the present system, each terminal 118 is programmable to store the desired business ID 120.

Each terminal 118 is in communication with a server 119 via a network 113. The network 113 includes the Internet, a LAN, a WLAN, a telecommunications network, or any other means or allowing the terminal 118 and the server 119 to electronically communicate in a wired or wireless format. The server 119 includes a non-transitory computer readable medium, a logic stored within the computer readable medium, and a processor to execute the logic. The server 119 is connected to one or more databases 114. As executed by the processor, the logic receives from the terminal 118 the business ID 120 of the terminal 118 and the user ID 112 of the card 111 (as read by the terminal 118) and then queries the database 114 to retrieve the consumer information relevant to the business. Once the relevant consumer information is retrieved from the database 114, the server 119 returns the consumer information to the terminal 118 for utilization by the business.

The database 114 stores a user account 115 thereon that is unique to the given user. Each user account 115 has consumer information associated therewith that is relevant to purchasing transactions for businesses, such as a loyalty ID 116 of a loyalty membership program and a redeemable purchase ID 117 for a purchase that the consumer previously made with the business that is to be redeemed at a later time. Such redeemable purchases would include movie tickets, plane tickets, and the like. Loyalty membership programs include joinable programs run by businesses that allow consumers to obtain discounts on purchases, gain rewards points for purchases, and so on.

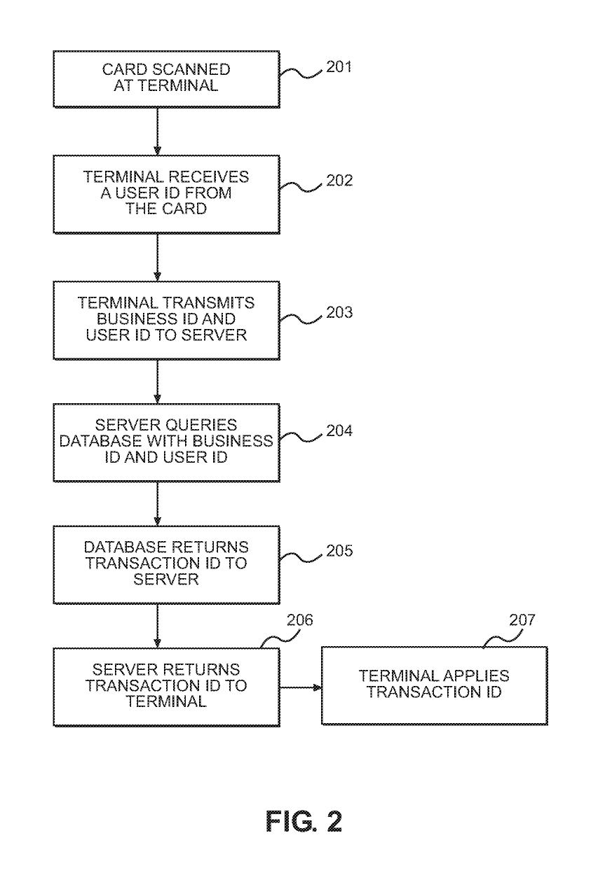

Referring now to FIG. 2, there is shown a flowchart of the method of use of an illustrative embodiment of the present system. Each participating business in the system has a terminal that has a business ID unique to the participating business stored thereon. When the card of the present system is scanned 201 at the terminal of a participating business, the terminal receives 202 the user ID that is stored on the card. The terminal can receive 202 this user ID by reading a magnetic strip, an RFID tag, a transponder, a microchip, or other storage media on the card encoding the user ID. After the terminal has received 202 the user ID, the terminal than transmits 203 the business ID and the user ID to a server of the present system.

Once the server receives the business ID and the user ID, the logic of the server then queries 204 a database in connection with the server with the user ID and the business ID. The database stores one or more user IDs and each of the one or more user IDs has one or more business IDs stored in association therewith. Furthermore, each business ID of each user ID then has a consumer transaction ID stored in association therewith. The consumer transaction IDs include loyalty IDs for loyalty rewards programs and IDs for redeemable purchases, such as plane tickets or movie tickets. Each of the user IDs is unique to a single user. Therefore, querying 204 the database with the user ID from the card and the business ID from the terminal at which the card is scanned allows a business participating in the present system to retrieve a desired consumer transaction number for application at the terminal without the need for the user to physically carry either a ticket for the redeemable purchase or a loyalty rewards card on his or her person.

In response to the query 204, the database returns 205 the transaction ID to the server, which then returns 206 the transaction ID to the terminal. The terminal then applies 207 the transaction ID as needed. For example, if the returned transaction ID is the ID for a loyalty rewards programs, then the terminal applies the loyalty rewards program discount to the consumer's transaction or otherwise tracks the user's purchase. Alternatively, if the returned transaction ID is a ticket number that the user previously purchased, then the terminal acknowledges the pre-purchase of the ticket in order to permit access to the event for the user.

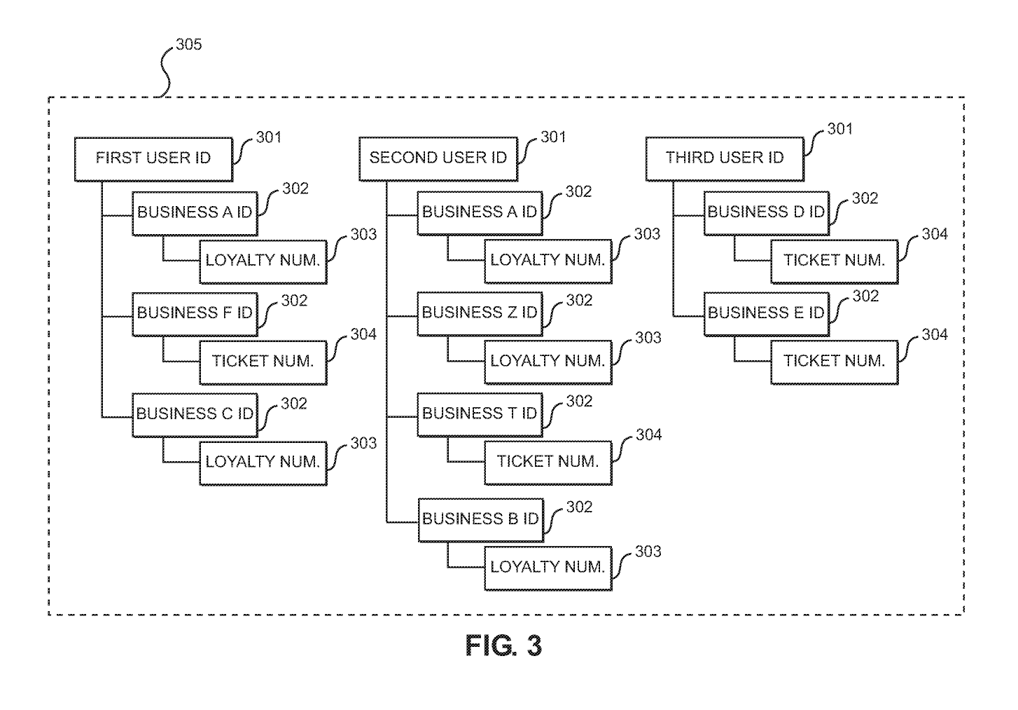

Referring now to FIG. 3, there is shown a diagram of a data structure of an illustrative embodiment of the present system. Each database 305 of the present system stores a plurality of user IDs 301, wherein each user ID is unique to each individual user of the present system. Each user ID 301 has one or more business IDs 302 stored in association therewith and each business ID in turn has a transaction ID, such as a loyalty number 303 or a ticket number 304, stored in association therewith. Each business ID 302 is unique to a specific business, as represented by hypothetical “BUSINESS A,” “BUSINESS F,” and the like. Therefore, querying the database with a two-stage search of the user ID 301 and the business ID 302 allows the present system to return the transaction ID relevant to the participating business.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A computer system, comprising:
a card storing a card user ID;
a server in connection with a database;
the database storing a user ID, a business ID associated with the user ID, and a transaction ID associated with the business ID of the used ID;
a terminal storing a terminal business ID; and
wherein scanning the card at the terminal causes the terminal to query the server with the card user ID and the terminal business ID via a network, whereupon the server returns to the terminal the transaction ID corresponding to the user ID matching the card user ID and the business ID matching the terminal business ID.

2) The computer system of claim 1, wherein the transaction ID includes a loyalty program ID and a redeemable purchase ID.

3) The computer system of claim 2, wherein the transaction ID is the loyalty program ID, the terminal applies the loyalty program ID to discount a purchase upon receipt of the loyalty program ID.

4) The computer system of claim 2, wherein the transaction ID is the redeemable purchase ID, the terminal applies the redeemable purchase ID to acknowledge payment of a purchase.

5) The computer system of claim 1, wherein the network includes the Internet.

6) The computer system of claim 1, wherein the business ID is unique to a participating business.

7) The computer system of claim 1, wherein the terminal includes a point-of-sale terminal.
